(19) United States
(12) Patent Application Publication
(10) Pub. No.: US 2025/0153223 A1
(43) Pub. Date: May 15, 2025

(54) A SORTER SYSTEM WITH PICK AND PLACE ROBOTS AND A METHOD FOR SORTING OBJECTS

(71) Applicant: Beumer Group GmbH & Co. KG, Beckum (DE)

(72) Inventors: Andreas Werner, Dortmund (DE); Jan Josef Jesper, Dulbrück (DE)

(73) Assignee: Beumer Group GmbH & Co. KG, Beckum (DE)

(21) Appl. No.: 18/839,462

(22) PCT Filed: Feb. 10, 2023
(86) PCT No.: PCT/EP2023/053367

§ 371 Date: Aug. 19, 2024

(30) Foreign Application Priority Data
Feb. 18, 2022 (EP) 22157412.2

(51) Int. Cl. B07C 5/36; B07C 5/34

(52) U.S. Cl. CPC B07C 5/362; B07C 5/3412; B07C 2501/0063

(57) ABSTRACT

The present invention concerns a method and a sorter system for handling a stream of objects of various shapes and sizes in bulk, the system comprising a feeder system comprising at least a first feeder section arranged to transport the objects to at least one receiving area; at least one transfer platform adjacent the feeder system, said transfer platform comprising said at least one receiving area and means for multi-directional transfer of the objects and a plurality of destination slots; wherein the destination slots are arranged around the transfer platform; a pick and place robot system comprising at least one controllable robot, wherein the at least one robot is configured with a controllable gripper arranged for picking objects from the at least first feeder section and placing objects on the adjacent transfer platform on which the objects are individually conveyed to the allocated destination slot, and a control system arranged to control movement of the plurality of robots and their grippers to pick objects from the first feeder section and transfer and place objects in selected destination slots; and a scanner system comprising at least one scanner configured to read information on each of the objects, and wherein the scanner system is configured to provide data to the control system according to the information read, so as to allow the pick and place robot system to place each object on a receiving point in the receiving area of the transfer platform and so as to control the transfer of the object from said receiving point on the transfer platform to the destination slot selected in accordance with information.

### FIELD OF THE INVENTION

The present invention relates to a sorter system for handling objects, specifically objects incoming in a 2D or 3D bulk. Specifically, the invention relates to a sorter system with pick and place robots for picking up incoming objects from a feeder and placing them directly at selected destinations. The sorter system is suitable for instance handling mail pieces, parcels, baggage, softbags, limp/non-rigid bags, polybags, items handled at a warehouse distribution, and items handled at a mail order distribution centre.

### BACKGROUND OF THE INVENTION

Sorters, for sorting objects such as mail and/or parcels or the like, normally include a sorter system based on a conveyor. The conveyor transports objects at a constant speed to a discharge position, and in accordance with a code or the like on the individual objects, the objects are discharged from the sorter at a given discharge position, i.e. at the destination selected for each object.

Normally, such sorter has a number of fixed positions, e.g. on totes or trays, where one single object is received and transported to the discharge to arrive at its final destination. Thus, to induct objects to the sorter from a 3D bulk of objects, e.g. an incoming stream of objects in 3D bulk, the objects needs to be singulated and placed on the fixed positions on the sorter. In sorter systems without automated inductions for handling the induction to the sorter, persons perform the rather unpleasant task of manually inducting objects to the sorter, either by placing objects directly on the sorter or by performing singulation and placing objects singulated on an induction which inducts the objects on the sorter.

Such a semi-automatic sorter system occupies a large area, especially if the system is required to have a high capacity, i.e. a high number of handled objects per time. This is caused by a high number of mechanical components involved in the handling of the objects from the input of objects in bulk to their final destinations, e.g. roller cages or other movable containers, thus being sorted and prepared for further handling.

### SUMMARY OF THE INVENTION

It is an object of the present invention to provide a more compact sorter system which requires a small footprint and which has a high capacity.

In a first aspect, the invention provides a sorter system for handling a stream of objects of various shapes and sizes in bulk, the system comprising
a feeder system comprising at least a first feeder section arranged to transport the objects to at least one receiving area;
at least one transfer platform adjacent the feeder system, said transfer platform comprising said at least one receiving area and means for multi-directional transfer of the objects and a plurality of destination slots; wherein the destination slots are arranged around the transfer platform;
a pick and place robot system comprising
   one or more controllable robots, wherein the at least one robot is configured with a manipulator, such as a controllable gripper, arranged for picking objects from the at least first feeder section and placing objects on the adjacent transfer platform on which the objects are individually conveyed to the allocated destination slot, and
   a control system arranged to control movement of the plurality of robots and their manipulators to pick objects from the first feeder section and transfer the objects on the adjacent transfer platform on which the objects are individually conveyed to the allocated destination slot and place the objects in selected destination slots; and
a scanner system comprising at least one scanner configured to read information on each of the objects, and wherein the scanner system is configured to provide data to the control system according to the information read, so as to allow the pick and place robot system to place each object on a receiving point in the receiving area of the transfer platform and so as to control the transfer of the object from said receiving point on the transfer platform to the destination slot selected in accordance with information.

By sorting the objects, such as parcels or the like, in a matrix sorter with the transfer platform being capable of transferring objects in a multiple of destinations, a very high sorting capacity may be achieved on a very compact sorting system which takes up a relative small amount of space.

The advantages of a sorter system according to the invention are the significant optimization of the planning, and adaptation of the layout or throughput related to the specific requirements of the sorting system in a specific location. For instance, it would be possible that, depending on the season or situation, the system can be adapted to better absorb annual peaks in the amount and types of objects to be handled.

The particular configuration of the sorter system can be in a modularly design and can achieve through the control, new areas of application compared to existing sorter systems, for example sequencing of the orders. This may be advantageous as a modular layout can be adapted to the needs of peak times where extra capacity is needed.

In a preferred embodiment, the transfer platform is organised as a grid with a plurality of substantially orthogonal transport rows. This allows for a versatile control strategy.

In particular, it is preferable in one first embodiment, the means for multi-directional transfer comprises a system substantially orthogonal conveyors.

In some preferred embodiments of the invention, the means for multi-directional transfer comprises means for omni-directional transfer of the objects, which comprises a plurality of mobile robots or automatic guided vehicles adapted for moving along the rows of the grid. In other embodiments, the means for multi-directional transfer comprises means for omni-directional transfer of the objects, which comprises multiple individually driven conveyor modules arranged in a grid configuration on the transfer platform. Thus, the type of means for omni-directional transfer of the objects may be chosen according to the specific circumstances of the implementation of the sorter system.

The at least one receiving area advantageously comprises a plurality of receiving points in one or more rows adjacent a feeding section, and wherein the portal structure of the robot system can reach all of said receiving points. In particular, the receiving points are configured as one or more adjacent rows on the transfer platform next to the feeder section that the robot system can reach and thereby deliver an object for further transportation. Hereby, a particularly compact lay-out of the sorting system may be achieved.

In the currently preferred embodiment, the destination slots are destination bins, such as roller cages, containers, roller containers, bags, etc. In particular, the destination slots preferably comprise chutes for receiving the object from the transfer platform and directing said object into collection means, such as the destination bin. However, it is realised that other designs of destination slots may be provided for collecting the objects once sorted.

In one embodiment of the sorter system according to the invention, the scanner system is provided at the feeder system so that the objects are scanned before being gripped by the robot or robots. Hereby, the objects are scanned before reaching the robots and therefore the control system can allocate a robot for the task of picking the individual objects.

In an alternative embodiment, the scanner system is provided at the robot system, for instance so that an object is picked by a robot from the bulk and presented to the scanner for scanning. According to this embodiment, the object is first picked by a robot and then scanned so that the control system can provide transfer instructions to the system for the picked object.

Preferably, the scanner system is adapted to read information in the form of scan codes on the objects. The scan code may be a barcode, a QR code or any other type of visually identifiable graphic label, inscription or the like provided on the objects. However, other visual identification means for identifying the object to be handled in the sorter may also be provided, such as image recognition or the like.

In one embodiment of the invention, the pick and place robot system comprises at least one portal structure carrying the one or more controllable robots in a gantry configuration and being controllably movable along said portal structure, and wherein the at least one robot is configured with a controllable gripper arranged for picking objects from the at least first feeder section and placing objects on the adjacent transfer platform on which the objects are individually conveyed to the allocated destination slot. Using a portal structure for moving the robots for performing the pick and place actions may be one embodiment which is simple to control.

In an embodiment, the pick and place robot system comprises a plurality of controllable robots each comprising a controllable articulated arm, such as a six-axis controllable articulated arm. In particular, each of the plurality of controllable articulated arms may be mounted with its base at an elevated position relative to the first feeder section. This may provide a flexible pick-and-place operation. However, it is realised that other types of robots may also be used without departing from the invention.

In one embodiment for large capacity, the pick and place robot system comprises a first plurality of controllable robots positioned on one side of the first feeder section, and a second plurality of controllable robots positioned on an opposite side of the first feeder section.

In one embodiment of the sorter system of the invention, the layout configuration of the transfer platform is rectangular with four sides, where one feeder section and one robot portal structure are provided along one side thereof and where destination slots are provided at least along one or more of the other three sides of said transfer platform.

In other embodiments, the configuration of the sorter system may involve that the feeder system comprises a first and a second feeder section provided on different locations on the transfer platform, such as on two sides, where associated robot portal structures are also provided.

In yet another configuration, a central feeder section may be provided with an associated robot portal structure and with transfer platforms on each side thereof.

Moreover, the destination slots may also be provided in the grid on the transfer platform either as an alternative to providing the destination slots along the sides or as a supplement to this.

These different configurations of the transfer platform and the positions of the destination slots may be provided as alternatives or used together according to the actual circumstances and requirements of the sorter installation.

In one embodiment of the invention, the plurality of controllable robots comprise a manipulator comprising a comb structure having a plurality of fingers arranged to be inserted below an object for picking the object by lifting the object by means of the fingers. In particular, the manipulator may preferably comprise a comb structure with at least four fingers at fixed positions. Furthermore, said manipulator is connected to an arm of the controllable robot so as to allow the comb structure to be tilted for unloading an object, such as tilted around a horizontal axis.

In order to use this simple comb manipulator, it is advantageous that the first feeder section comprises a roller conveyor for transporting objects, and wherein the fingers of the comb structure of the manipulator are spaced to fit a distance between the rollers of the roller conveyor, so as to allow the fingers to be inserted along the rollers to lift an object positioned on a surface of the rollers.

Preferably, at least one scanner positioned upstream of the first feeder section and being arranged provide data to the control system in accordance with information read from a scanning code on the object, and a vision system, such a comprising a 2D or 3D camera, wherein the vision system is arranged to provide an image of the object upstream of the first feeder section, and wherein the control system is arranged to store the data read from the scanning code linked to data indicative of the image of the object.

Preferably, the control system is arranged to track position of an object in the feeder system based on the stored data indicative of the data indicative of the image of the object provided upstream of the first feeder section.

Furthermore, the vision system preferably comprises a plurality of cameras at respective positions in the feeder system to provide images of objects transported by the feeder system, so as to allow the control system to track objects based on providing images of objects at respective positions in the feeder system.

In a second aspect of the invention, a plurality of sorter system such as described above, wherein the sorter systems are provided as modules with a common control system. Hereby, a flexibility in the sorter system may be achieved.

In a third aspect of the invention, there is provided a method of handling a stream of objects of various shapes and sizes in bulk, the method comprising the steps of:
feeding a bulk of objects in a feeder system, wherein said objects are transported to at least a first feeder section, and
transferred to at least one receiving area of at least one transfer platform adjacent the feeder system, said transfer platform comprising said at least one receiving area and means for multi-directional transfer of the objects and a plurality of destination slots; wherein the destination slots are arranged around the transfer platform;
said transfer is performed by a pick and place robot system comprising at least one controllable robot, wherein the at least one robot is configured with a manipulator, such as a controllable gripper, arranged for picking objects from the at least first feeder section and placing objects on the adjacent transfer platform on which the objects are individually conveyed to the allocated destination slot, and a control system arranged to control movement of the plurality of robots and their grippers to pick objects from the first feeder section and transfer and place objects in selected destination slots; and whereby the objects are scanned in a scanner system comprising at least one scanner configured to read information on each of the objects, and whereby the scanner system is configured to provide data to the control system according to the information read, so as to allow the pick and place robot system to place each object on a receiving point in the receiving area of the transfer platform and so as to control the transfer of the object from said receiving point on the transfer platform to the destination slot selected in accordance with information.

The method may be adapted to be performed by a sorter system according to any of the embodiments described in this disclosure.

By the method of this aspect, the sorting of the objects, such as parcels or the like, are done using a matrix-like sorter with the transfer platform being capable of transferring objects in a multiple of destinations. Hereby, a very high sorting capacity may be achieved on a very compact sorting system which takes up a relative small amount of space. This is advantageous as there is achieved a significant optimization of the planning, and adaptation of the layout or throughput related to the specific requirements of the sorting system in a specific location and for a specific requirement. For instance, it would be possible that, depending on the season or situation, the system can be adapted to better absorb annual peaks in the amount and types of objects to be handled.

### DETAILED DESCRIPTION

In the following the invention is described in more detail with reference to the embodiments shown in the accompanying drawings, in which:

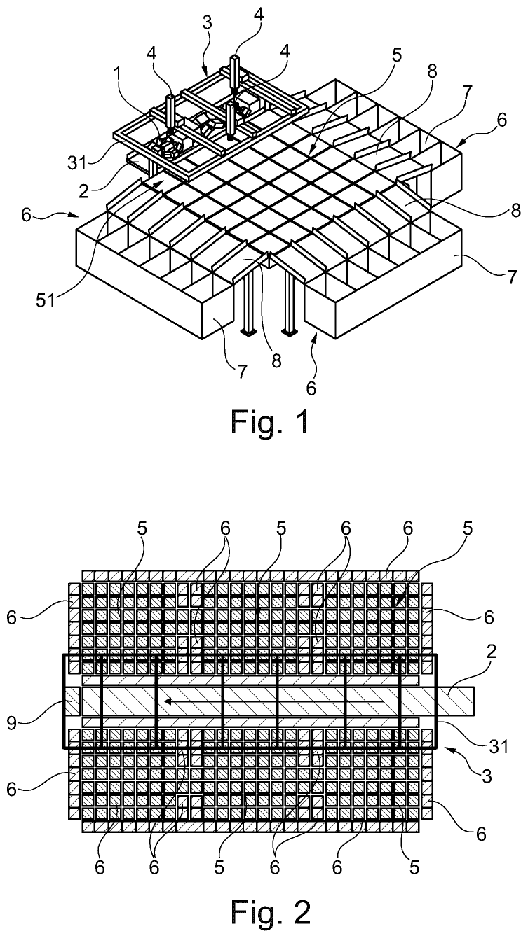

FIG. 1 is a perspective view of a first embodiment of a sorter system according to the invention;

FIG. 2 is a schematic top view of a second embodiment of a sorter system according to the invention,

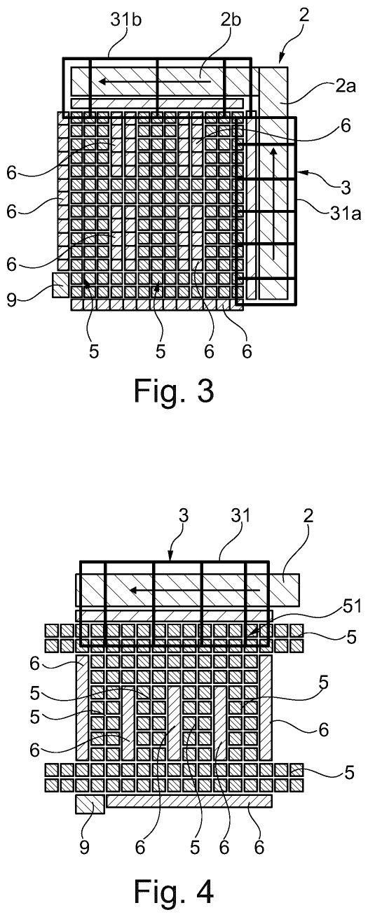

FIGS. 3 to 5 are schematic top views of further embodiments of a sorter system according to the invention,

FIGS. 6 to 8 are further embodiments of a sorter system according to the invention; and

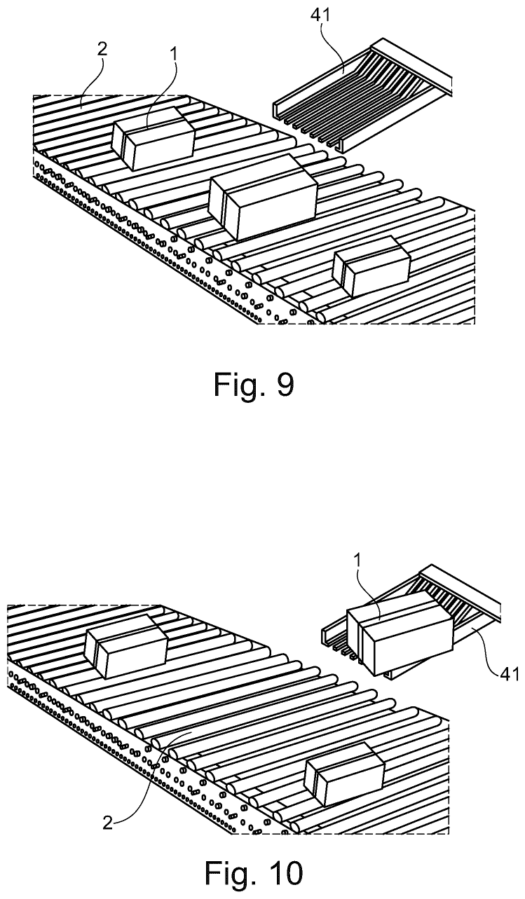

FIGS. 9 and 10 illustrate views of a gripper embodiment based on a comb structure for lifting objects.

With reference to FIG. 1, there is provided a sorter system for handling a stream of objects 1 of various shapes and sizes in bulk. The objects 1 may be mail pieces, parcels, baggage, softbags, limp/non-rigid bags, polybags, items handled at a warehouse distribution, and items handled at a mail order distribution centre.

The objects 1 are placed as 2D or 3D bulk on a feeder section 2, and then use pick and place robot system 3 having one or more robots 4 to grab the objects 1 from the feeder section 2 and place them on a receiving point on the receiving area 51 in the adjacent transfer platform 5. The transfer platform 5 is configured as in a grid structure (or matrix structure) with a plurality of rows in two directions that are orthogonal to each other so as to provide for multi-directional transfer of the objects 1 to a plurality of destination slots 6 that in this embodiment are arranged around the sides of the transfer platform 5.

The destination slots 6 may be destination bins 7, such as roller cages, and where chutes 8 are provided between the periphery of the transfer platform 5 and the bins 7 for receiving an object 1 from the transfer platform 5 and directing said object 1 into the destination bin 7.

The pick and place robot system 3 comprises a portal structure 31 carrying one or more controllable robots 4 in a gantry configuration that are controllably movable along said portal structure 31. The robots are provided with a controllable gripper (not shown in the figures) arranged for picking objects from the feeder section 2 and placing objects on the adjacent transfer platform 5 on which the objects 1 are individually conveyed to the allocated destination slots 6. The portal structure 31 of the robot system 3 is designed so that all of said receiving points of the receiving row 51 or rows (see FIG. 2) can be reached.

The transfer platform 5 is preferably configured as a grid with a plurality of substantially orthogonal transport rows for instance comprising substantially orthogonal conveyors.

In other embodiments, the means for multi-directional transfer in the form of orthogonal transport rows comprises a plurality of mobile robots or automatic guided vehicles adapted for moving along the rows of the grid.

In the sorter system shown in FIG. 1, the transfer platform 5 is rectangular with four sides, where the feeder section 2 and one robot portal structure 31 are provided along one side thereof and where destination slots 6 are provided at least along the other three sides of said transfer platform 5. As shown in the FIGS. 2-5 other configurations of the sorter system may be provided.

In FIG. 2, there is shown a configuration with a central feeder section 2 is provided with an associated robot portal structure 31 and with a plurality of sections of transfer platforms 5 on each side thereof. The destination slots 6 are provided around the edges of the transfer platforms 5 as well as in some sections between or “inside” the sections of the transfer platform 5. The destination slots 6 may be provided as chutes leading the objects to a bin as in FIG. 1 and/or any other collection system. At the end of the feeder section 1 there is provided a return path reception 9 for receiving non-picked objects 1 and returning these non-picked objects on a return path (not shown) to the inlet of the feeder system.

In FIG. 3, the feeder system comprises a first and a second feeder section 2a, 2b provided on different locations on the transfer platform 5, such as on two sides, where associated robot portal structures 31a, 31b are also provided. The transfer platform 5 is configured in a grid structure but with a more complex outer contour. The destination slots 6 may eb proved along the outer edges of the transfer platform 5 as well as within the grid on the transfer platform 5. Also in the embodiment shown in FIG. 3, the sorter system may also comprise a return path reception 9, which as shown in FIG. 3 may be provided one the edge of the transfer platform 5.

In FIG. 4, the sorter system comprises one feeding section 2 with an associated robot system 3 with a portal structure 31 that reaches a receiving area 51 comprising two rows in the transfer platform 5. The transfer platform 5 is provided with destination slots 6 between the conveyor paths in the grid.

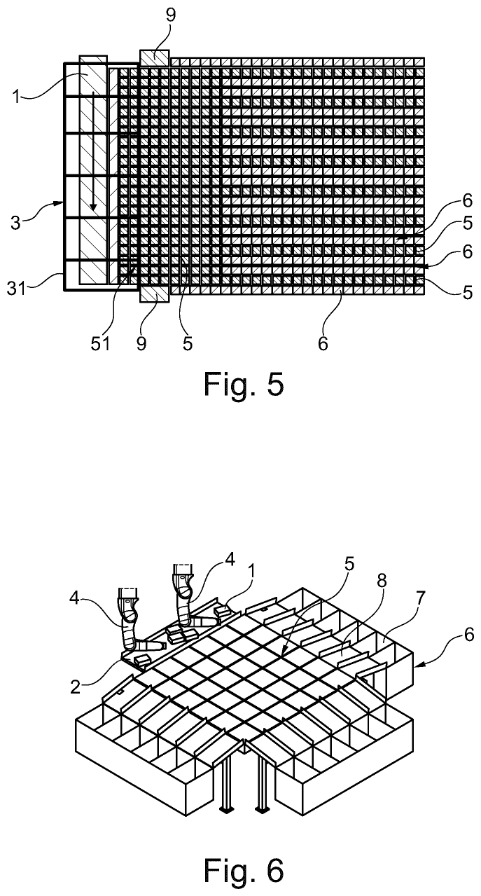

In FIG. 5 yet another embodiment of the grid configuration of the transfer platform is shown. Here, the objects are picked from the feeding section 1 by the robot system 3 and delivered in the receiving area 51 of the transfer platform 5. The transfer platform 5 is formed with rows having destination slots 6 inbetween to provide a high amount of possible destination slots. Also return path receptions 9 may be provided for objects than cannot be delivered in any destination bin.

In the figures some different examples of the configuration of the sorter system are shown. As apparent from these examples various configurations of such a matrix sorter system may be provided, which is advantageous as the sorter system according to the invention provides great flexibility and may ensure a high sorting capacity.

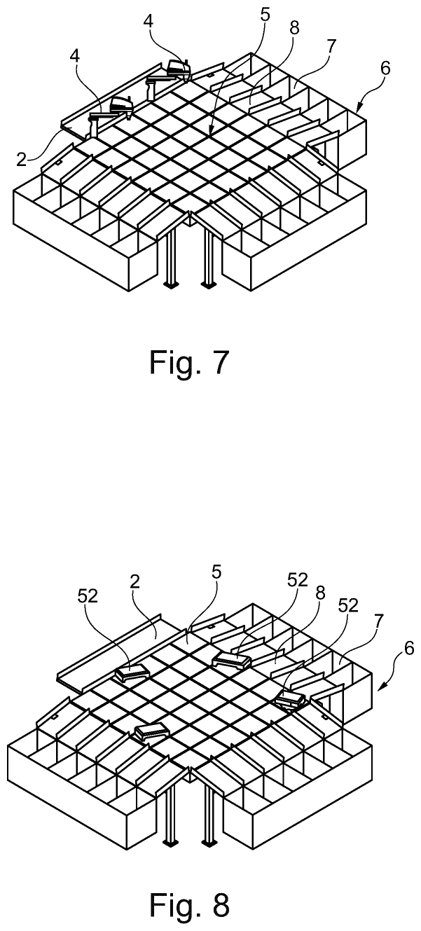

In FIGS. 6 to 8 three further embodiments of the sorter system are shown, where different types of robots are used instead of the gantry robots shown in FIG. 1. For instance the robots 4 may be robots with controllable articulated arms (FIG. 6) or swinging arms (FIG. 7) for picking the objects 1 off the feeder section 2 and placing them on the transfer platform 5.

As shown in FIG. 8, the objects may be placed on the transfer platform 5 on AGVs 52 (autonomous guided vehicles) which are provided on the platform 5 for performing the transfer of the objects.

Although not shown In the figures, common for the embodiments according to the invention is that the system is also provided with a control system arranged to control movement of the plurality of robots and their grippers to pick objects from the first feeder section and transfer and place objects in selected destination slots. Furthermore, a scanner system is provided comprising at least one scanner configured to read information on each of the objects, and wherein the scanner system is configured to provide data to the control system according to the information read, so as to allow the pick and place robot system to place each object on a receiving point in the receiving area of the transfer platform and so as to control the transfer of the object from said receiving point on the transfer platform to the destination slot selected in accordance with information.

The scanner system is adapted to read information in the form of scan codes on the objects. The scanner system may be provided at the feeder system, such as at the entry to the feeder section 1 so that the objects are scanned before being gripped by the robots. In another embodiment, the scanner system may be provided at the robot system, for instance so that an object is picked by a robot from the bulk and presented to the scanner for scanning.

It is to be understood that in principle, all types of objects or items can be handled by the described robot systems. I.e. objects or items can be of various shapes, sizes, and with various surface characteristics. Especially, the stream of objects or items arriving at the feeding system may comprise at least one of: mail pieces, parcels, baggage, items handled at a warehouse distribution, and items handled at a mail order distribution centre, such as shoes, clothes, textiles etc. Especially, the robot system and the transfer platform are designed for handling objects or items which have a maximum weight of 1-100 kg, such as 1-10 kg, such as a maximum weight of 2-3 kg. Especially, objects or items with a maximum weight of 2-3 kg can be picked up and moved at a high speed even with moderately sized robots. It is to be understood that the robot system can alternatively be designed for handling heavier objects than 100 kg.

It is understood that the function of control system is preferably implemented by a processor system. The processor may be a computerized controller including a digital processor executing the control algorithm which is implemented in software, so as to allow easy updating and adaptation of the function of the system, e.g. by changes in sorter configuration, and by including more pick and place robots to the system which need to be controlled in order to most effectively cooperate to handle the incoming stream of objects or items.

In some embodiments, the control system can be implemented by means of a Programmable Logic Controller (PLC). The processor may be or may comprise a dedicated robot controlling processor, or it may be implemented as part of or sharing the processor serving to control the sorter. Hereby, the addition of one or more pick and place robots to an existing sorter system may be implemented with a minimum of extra hardware for controlling the robot(s), and thus in such implementations, the program code for controlling the robot(s) can be implemented purely as processor executable program code. Likewise, the processor may be implemented as part of or sharing the processor serving to control the one or more induction for transporting items to the sorter. Still further, the processor may be implemented as part of or sharing the processor serving to control the feeder and/or the sorter, which may be advantageous to allow information from feeder and/or sorter to be used in the control of the pick and place robots. Yet other versions may have separate robot controls with interfaces to one common machine controller for controlling sorter, inductions and feeding conveyor(s). The machine controller may then have an interface to an overall system controller, which may have an interface to an ever higher order control, e.g. a Warehouse Management System (WMS).

The control system can be performed with many of its functions implemented as computer program code, and in practice, the program code may be partly or fully integrated with existing systems for controlling the sorter. However, it may be preferred that the control system has two or more separate processors, e.g. a separate processor serving to perform at least some of the required image processing on one or a plurality of images, e.g. 3D images to provide a fast and precise identification of objects upstream of each of the pick and place robots.

The sorter system may have a capacity for handling at least 2,000 objects per hour, preferably at least 3,000 objects per hour, especially for smalls. For heavy parts or baggage, the handling capacity may be smaller than 2,000 objects per hour or even up to 5,000 objects per hour may be obtained.

The first feeder section may be arranged to operate at a transporting speed of up to 1.0 m/s, such as up to 1.5 m/s. For bulk unloading an initial speed of 0.1-0.3 m/s may be preferred, and thereafter a speed of such as 0.5-1.2 m/s.

The method of sorting on the sorter system preferably comprises the step of providing the objects 1 on the first feeder section 2. The step of reading information on each object 1 may be performed prior to providing the objects 1 on the first feeder section 2, e.g. along with a step of providing an image of the objects and to further link information read on each object with images provided of the respective objects. Alternatively, the step of reading information, e.g. scanning, may be performed along with the robots picking the objects.

FIGS. 9 and 10 shows an example of a rather simple manipulator or gripper 41 to be used for picking objects by the pick and place robots. This gripper 41 has a comb structure with a plurality of fingers, e.g. comprising 4-12 fingers, wherein these fingers are arranged to be inserted below an object for picking the object 1 by lifting the object 1 by means of the fingers.

Especially, the comb gripper 41 is preferably combined with a feeder section 2 in the form of a roller conveyor, i.e. a conveyor having a line of rollers spaced at a distance, and being arranged to transport an object on its surface, as shown in FIGS. 9 and 10. The fingers of the gripper 41 are spaced to fit a distance between the rollers of the roller conveyor, so as to allow the fingers to be inserted along the rollers of the roller conveyor and to lift an object 1 positioned on a surface of the rollers while the fingers of the gripper 41 are inserted along the rollers, thereby picking the object 1, as shown in FIG. 10, where the gripper41 carries and object 1 on the fingers.

In preferred implementations, the gripper 41 is connected to a robot arm which allows the gripper 41 to tilt, so as to allow the gripper 41 to unload the object 1, e.g. to unload the object 1 onto another conveyor or the like on the transfer platform. Especially, the gripper 41 may be hinged on a horizontal axis, so as to allow tilting around a horizontal axis to unload the object. This allows the gripper 41 to be in a position where the fingers are controlled to be in a horizontal or substantially horizontal position when picking up and carrying an object, as seen in FIGS. 9 and 10, while the gripper 41 is controlled to be tilted so the fingers point downwards for unloading the object.

In general, when directional terms like “horizontal” and “vertical” or similar directional references are used in the present disclosure, these terms are meant to be understood as relative terms e.g. where the term “vertical” refers to a direction essentially perpendicular to the substrate surface, and “horizontal” refers to a direction essentially parallel to the substrate.

Although the present invention has been described in connection with the specified embodiments, it should not be construed as being in any way limited to the presented examples. The scope of the present invention is to be interpreted in the light of the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A sorter system for handling a stream of objects of various shapes and sizes in bulk, the system comprising
a feeder system comprising at least a first feeder section arranged to transport the objects to at least one receiving area;
at least one transfer platform adjacent the feeder system, said transfer platform comprising said at least one receiving area and means for multi-directional transfer of the objects and a plurality of destination slots; wherein the destination slots are arranged around the transfer platform;
a pick and place robot system comprising
one or more controllable robots, wherein the at least one robot is configured with a manipulator, such as a controllable gripper, arranged for picking objects from the at least first feeder section and placing objects on the adjacent transfer platform on which the objects are individually conveyed to the allocated destination slot, and
a control system arranged to control movement of the plurality of robots and their manipulators to pick objects from the first feeder section and transfer the objects on the adjacent transfer platform on which the objects are individually conveyed to the allocated destination slot and place the objects in selected destination slots; and
a scanner system comprising at least one scanner configured to read information on each of the objects, and wherein the scanner system is configured to provide data to the control system according to the information read, so as to allow the pick and place robot system to place each object on a receiving point in the receiving area of the transfer platform and so as to control the transfer of the object from said receiving point on the transfer platform to the destination slot selected in accordance with information.

2. A sorter system according to claim 1, wherein the transfer platform is organised as a grid with a plurality of substantially orthogonal transport rows.

3. A sorter system according to claim 1, wherein the means for multi-directional transfer comprises a system substantially orthogonal conveyors.

4. A sorter system according to claim 1, wherein the means for multi-directional transfer comprises means for omni-directional transfer of the objects, which comprises a plurality of mobile robots or automatic guided vehicles adapted for moving along the rows of the grid.

5. A sorter system according to claim 1, wherein the means for multi-directional transfer comprises means for omni-directional transfer of the objects, which comprises multiple individually driven conveyor modules arranged in a grid configuration on the transfer platform.

6. A sorter system according to claim 1, wherein the at least one receiving area comprises a plurality of receiving points in one or more rows adjacent a feeding section, and wherein the robot system can reach all of said receiving points.

7. A sorter system according to claim 1, wherein the destination slots are destination bins, such as roller cages.

8. A sorter system according to claim 1, wherein the destination slots preferably comprise chutes for receiving the object from the transfer platform and directing said object into collection means, such as the destination bin, and more preferably the chutes are modular in order to change the layout in a short time.

9. A sorter system according to claim 1, wherein the scanner system is provided at the feeder system so that the objects are scanned before being gripped by the one or more robots.

10. A sorter system according to claim 1, wherein the scanner system is provided at the robot system, for instance so that an object is picked by a robot from the bulk and presented to the scanner for scanning.

11. A sorter system according to claim 1, wherein the scanner system is adapted to read information in the form of scan codes on the objects.

12. A sorter system according to claim 1, wherein the pick and place robot system comprises at least one portal structure carrying the one or more controllable robots in a gantry configuration and being controllably movable along said portal structure, and wherein the at least one robot is configured with a controllable gripper arranged for picking objects from the at least first feeder section and placing objects on the adjacent transfer platform on which the objects are individually conveyed to the allocated destination slot.

13. The system according to claim 1, wherein the pick and place robot system comprises a plurality of controllable robots each comprising a controllable articulated arm, such as a six-axis controllable articulated arm.

14. The system according to claim 1, wherein the pick and place robot system comprises a first plurality of controllable robots positioned on one side of the first feeder section, and a second plurality of controllable robots positioned on an opposite side of the first feeder section.

15. A sorter system according to claim 1, wherein the transfer platform is rectangular with four sides, where one feeder section and one robot portal structure are provided along one side thereof and where destination slots are provided at least along one or more of the other three sides of said transfer platform.

16. A sorter system according to claim 1, wherein the feeder system comprises a first and a second feeder section provided on different locations on the transfer platform, such as on two sides, where associated robot portal structures are also provided.

17. A sorter system according to claim 1, wherein a central feeder section is provided with an associated robot portal structure and with transfer platforms on each side thereof.

18. A sorter system according to claim 1, wherein the destination slots are provided in the grid on the transfer platform.

19. The system according to claim 13, wherein each of the plurality of controllable articulated arms are mounted with its base at an elevated position relative to the first feeder section.

20. The system according to claim 13, wherein the plurality of controllable robots comprise a manipulator comprising a comb structure having a plurality of fingers arranged to be inserted below an object for picking the object by lifting the object by means of the fingers.

21. The system according to claim 20, wherein said manipulator comprises a comb structure with at least four fingers at fixed positions.

22. The system according to claim 20, wherein said manipulator is connected to an arm of the controllable robot so as to allow the comb structure to be tilted for unloading an object, such as tilted around a horizontal axis.

23. The system according to claim 21, wherein the first feeder section comprises a roller conveyor for transporting objects, and wherein the fingers of the comb structure of the manipulator are spaced to fit a distance between the rollers of the roller conveyor, so as to allow the fingers to be inserted along the rollers to lift an object positioned on a surface of the rollers.

24. The system according to claim 20, comprising one scanner positioned upstream of the first feeder section and being arranged provide data to the control system in accordance with information read from a scanning code on the object, and a vision system, such a comprising a 2D or 3D camera, wherein the vision system is arranged to provide an image of the object upstream of the first feeder section, and wherein the control system is arranged to store the data read from the scanning code linked to data indicative of the image of the object.

25. The system according to claim 24, wherein the control system is arranged to track position of an object in the feeder system based on the stored data indicative of the data indicative of the image of the object provided upstream of the first feeder section.

26. The system according to claim 25, wherein the vision system comprises a plurality of cameras at respective positions in the feeder system to provide images of objects transported by the feeder system, so as to allow the control system to track objects based on providing images of objects at respective positions in the feeder system.

27. A plurality of sorter systems according to claim 1, wherein the sorter systems are provided as modules with a common control system.

28. Use of the system according to claim 1 for handling objects comprising at least one of: mail pieces, parcels, baggage, items handled at a warehouse distribution, items handled at a mail order distribution centre, and items handled at a smalls handling centre.

29. A method of handling a stream of objects of various shapes and sizes in bulk, the method comprising the steps of:
feeding a bulk of objects in a feeder system, wherein said objects are transported to at least a first feeder section, and
transferred to at least one receiving area of at least one transfer platform adjacent the feeder system, said transfer platform comprising said at least one receiving area and means for multi-directional transfer of the objects and a plurality of destination slots;
wherein the destination slots are arranged around the transfer platform;
said transfer is performed by a pick and place robot system comprising at least one controllable robot, wherein the at least one robot is configured with a manipulator, such as a controllable gripper, arranged for picking objects from the at least first feeder section and placing objects on the adjacent transfer platform on which the objects are individually conveyed to the allocated destination slot, and a control system arranged to control movement of the plurality of robots and their grippers to pick objects from the first feeder section and transfer and place objects in selected destination slots; and whereby
the objects are scanned in a scanner system comprising at least one scanner configured to read information on each of the objects, and whereby the scanner system is configured to provide data to the control system according to the information read, so as to allow the pick and place robot system to place each object on a receiving point in the receiving area of the transfer platform and so as to control the transfer of the object from said receiving point on the transfer platform to the destination slot selected in accordance with information.

30. A method according to claim 29, whereby the scanner system is provided in or before the feeder system so that the objects are scanned before being gripped by the one or more robots.

31. A method according to claim 29, whereby the scanner system is provided at the robot system, for instance so that an object is picked by a robot from the bulk and presented to the scanner for scanning.

32. A method according to claim 29, whereby the scanner system is adapted to read information in the form of scan codes on the objects.

33. A method according to claim 29, whereby the pick and place robot system comprises at least one portal structure carrying the one or more controllable robots in a gantry configuration and being controllably movable along said portal structure, and wherein the at least one robot is configured with a controllable gripper arranged for picking objects from the at least first feeder section and placing objects on the adjacent transfer platform on which the objects are individually conveyed to the allocated destination slot.

34. A method according to claim 29, whereby the pick and place robot system comprises a plurality of controllable robots each comprising a controllable articulated arm, such as a six-axis controllable articulated arm.

35. A method according to claim 29, whereby the pick and place robot system comprises a first plurality of controllable robots positioned on one side of the first feeder section, and a second plurality of controllable robots positioned on an opposite side of the first feeder section.

36. A method according to claim 29, whereby the method is performed by a sorter system comprising:
a feeder system comprising at least a first feeder section arranged to transport the objects to at least one receiving area;
at least one transfer platform adjacent the feeder system, said transfer platform comprising said at least one receiving area and means for multi-directional transfer of the objects and a plurality of destination slots; wherein the destination slots are arranged around the transfer platform;
a pick and place robot system comprising
one or more controllable robots, wherein the at least one robot is configured with a manipulator, such as a controllable gripper, arranged for picking objects from the at least first feeder section and placing objects on the adjacent transfer platform on which the objects are individually conveyed to the allocated destination slot, and
a control system arranged to control movement of the plurality of robots and their manipulators to pick objects from the first feeder section and transfer the objects on the adjacent transfer platform on which the objects are individually conveyed to the allocated destination slot and place the objects in selected destination slots; and
a scanner system comprising at least one scanner configured to read information on each of the objects, and wherein the scanner system is configured to provide data to the control system according to the information read, so as to allow the pick and place robot system to place each object on a receiving point in the receiving area of the transfer platform and so as to control the transfer of the object from said receiving point on the transfer platform to the destination slot selected in accordance with information.
